(19) United States
(12) Patent Application Publication
(10) Pub. No.: US 2023/0235613 A1
(43) Pub. Date: Jul. 27, 2023

(54) Apparatus for Covering a Door Frame and a Door Slab Perimeter

(71) Applicant: Zeljko Petrovic, Beaconsfield (CA)

(72) Inventor: Zeljko Petrovic, Beaconsfield (CA)

(21) Appl. No.: 17/927,933

(22) PCT Filed: May 27, 2021
(86) PCT No.: PCT/CA2021/050715

§ 371 Date: Nov. 28, 2022

Related U.S. Application Data
(60) Provisional application No. 63/031,394, filed on May 28, 2020.

(51) Int. Cl. E06B 1/34; E06B 1/04; E06B 7/23

(52) U.S. Cl. CPC E06B 1/34; E06B 1/045; E06B 7/2307; E06B 1/06

(57) ABSTRACT

An apparatus for covering a door frame and a door slab perimeter. The apparatus includes a clip having a door frame shield and a door slab perimeter shield which extends from it. The clip has two connector sidewalls extending from the door frame shield towards a building interior. A clip receiver is located at one face of the door frame. The clip receiver is shaped to be complementary to the clip to permit a sealing engagement with it.

### TECHNICAL FIELD

The present generally concerns doors and door frames, and more particularly to modified doors and door frames for use with a residential or commercial entrance.

### BACKGROUND

Residential or commercial buildings generally speaking have one or more entrances such as doorways in which a door frame surrounds a door.

Typically, a door slab, the generally rectangular solid piece, is recessed inwardly away from the exterior wall of a building when hung on the door frame.

The door frames are made from wood and are covered on the outside with a covering such a Poly Vinyl Chloride (PVC) or an aluminum sheet, and painted to a desired colour, if needed. The whole frame is visible from the exterior of the building in which the door slab is recessed and in line with the inside wall.

Although recessed doors appear to be the conventional design for most if not all commercial and residential building, this design has some inherent problems. For example, and indeed disadvantageously, in locations where winters are cold and snow fall is heavy, a recessed door set back into the frame can allow snow and ice to accumulate. This makes access to the door difficult and in some cases hazardous. Furthermore, a recessed door may tend to collect dirt, which can be difficult to remove. Furthermore, the recessed door may also make regular maintenance difficult and problematic because the hingers are difficult to access, especially in confined spaces, especially if the door recess is small.

Thus, there is a need for an aesthetically pleasing and functional door frame and door covering system.

### BRIEF SUMMARY

The inventor has addressed the aforesaid problems by developing a new and unobvious modified door frame in which a one-piece clip is secured to the door frame and overlaps both the frame and the perimeter of the door slab. This advantageously improves the aesthetic appearance of the door and door frame by making the door and door frame co-planar (flush) with the exterior wall of the building. In addition to the aesthetic advantages, the door-to-frame sealing is significantly improved by locating PVC seals and gaskets at key locations around the frame to temporarily seal the door in the frame, and ensures the door and frame are flush with the exterior building wall when the door is closed.

Accordingly, in one embodiment there is provided an apparatus for covering a door frame and a door slab perimeter, the apparatus comprising:
a clip member having a door frame shielding portion and a door slab perimeter shielding portion extending therefrom, the clip member having first and second connector sidewalls extending from the door frame shielding portion towards a building interior; and
a clip member receiving portion located at one face of the door frame, the clip member receiving portion being shaped to be complementary to the clip member to permit sealing engagement therewith.

In one example, the door frame shielding portion and the door slab perimeter shielding portion are connected together.

In one example, the door slab perimeter shielding portion and the door frame shielding portion have a front facing surface which is disposed away from the door frame and the door slab; and a rear facing surface which is disposed inwardly towards the building interior.

In another example, the first connector sidewall is connected to a first end portion of the door frame shielding portion and extending inwardly therefrom towards the building interior, the first connector sidewall being disposed orthogonal to the door frame shielding portion; and the second connector sidewall is connected to a second end portion of the door frame shielding portion and extending inwardly therefrom towards the building interior, the second connector sidewall is disposed orthogonal to the door frame shielding portion. The second connector sidewall includes an anchor portion connected to an end portion of the second connector sidewall, the anchor portion being orthogonally disposed into the door frame and is orientated towards a building wall portion. The door frame includes: a door frame face disposed away from the building interior and includes: i) a first recess to sealingly receive therein the first connecting sidewall; ii) a second recess to sealingly receive therein the second connecting sidewall; and iii) a third recess to sealingly receive therein the anchor portion.

In one example, the door slab shielding portion includes first and second spaced apart recesses to receive therein first and second seals. The first and second seals are rubber gaskets.

In another example, the clip member is one-piece.

In another example, the door frame includes four frame pieces, a door sill clip is located at a base portion of the door frame.

Accordingly, in another embodiment there is provided an apparatus for covering a door frame and a perimeter of a door slab, the apparatus comprising:
a clip member having a door frame shielding portion and a door slab perimeter shielding portion extending therefrom, the clip member having first and second connector sidewalls extending from the door frame shielding sidewall, the door slab perimeter shielding portion and the door frame shielding portion have a front facing surface which is disposed away from the door frame and the door slab; and
a rear facing surface disposed inwardly towards a building interior; the first connector sidewall is connected to a first end portion of the door frame shielding portion and extending inwardly therefrom towards the building interior, the first connector sidewall being disposed orthogonal to the door frame shielding portion; the second connector sidewall is connected to a second end portion of the door frame shielding portion and extending inwardly therefrom towards the building interior, the second connector sidewall is disposed orthogonal to the door frame shielding portion; the second connector sidewall includes an anchor portion connected to an end portion of the second connector sidewall, the anchor portion is orthogonally disposed into the door frame and is orientated towards a building wall portion.

In another example, the door slab perimeter shielding portion includes first and second spaced apart recesses to receive therein first and second seals. The first and second seals are rubber gaskets.

In another example, the clip member is one-piece.

Accordingly, in another embodiment there is provided a door frame for a door, the door frame comprising:
first, second and third frame pieces, each frame piece having a contoured outer surface that are shaped to receive in a connecting manner, first, second and third clip members;
each frame piece having a clip member receiving portion located at a door frame face, the clip member receiving portion being shaped to be complimentary to the clip member to permit sealing engagement therewith; the door frame face includes:
i) a first recess to snuggly receive therein the first connecting sidewall in a sealing engagement;
ii) a second recess to snuggly receive therein the second connecting sidewall in a sealing engagement; and
iii) a third recess to snuggly receive therein the anchor portion.

In one example, the door frame further includes a door sill located at a base portion of the door frame and having a contoured outer surface that is shaped to receive in a doo sill clip member.

Accordingly, in another embodiment, there is provided a clip for use with a door frame and a perimeter of a door slab to cover same, the clip comprising
a door frame shielding portion and a door slab perimeter shielding portion extending therefrom;
first and second connector sidewalls extending from the door frame shielding sidewall, the door slab perimeter shielding portion and the door frame shielding portion have a front facing surface which is disposed away from the door frame and the door slab; and
a rear facing surface disposed inwardly towards a building interior;
the first connector sidewall is connected to a first end portion of the door frame shielding portion and extending inwardly therefrom towards the building interior, the first connector sidewall being disposed orthogonal to the door frame shielding portion;
the second connector sidewall is connected to a second end portion of the door frame shielding portion and extending inwardly therefrom towards the building interior, the second connector sidewall is disposed orthogonal to the door frame shielding portion;
the second connector sidewall includes an anchor portion connected to an end portion of the second connector sidewall, the anchor portion is orthogonally disposed into the door frame and is orientated towards a building wall portion.

In one example, the door slab perimeter shielding portion includes first and second spaced apart recesses to receive therein first and second seals. The first and second seals are rubber gaskets. The clip is one-piece.

### BRIEF DESCRIPTION OF THE DRAWINGS

These and other features of that described herein will become more apparent from the following description in which reference is made to the appended drawings wherein:

FIG. 1 is a perspective front view of a door frame and door slab located in a building entrance;

FIG. 2 is a perspective view of an embodiment of an assembled door frame and clip member;

FIG. 3 is a perspective exploded view of the door frame and clip member parts of FIG. 2;

FIG. 4 is a perspective close up partial view of the clip engaging the contoured door frame;

FIG. 5 is a partial side view of the clip member engaging the frame member;

FIG. 6 is a detailed plan view of the clip member and door frame in a sealed engagement;

FIG. 7 is a longitudinal side view of a clip member;

FIG. 8 is a perspective view of an elongate gasket;

FIG. 9 is a cross-sectional view of the gasket of FIG. 8;

FIG. 10 is a partial perspective view of a door sill with a door sill clip; and

FIG. 11 is a side view of the door sill clip of FIG. 10.

### DETAILED DESCRIPTION

### Definitions

Unless otherwise specified, the following definitions apply:

The singular forms “a”, “an” and “the” include corresponding plural references unless the context clearly dictates otherwise.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus, the phrase “consisting of” indicates that the listed elements are required or mandatory and that no other elements may be present.

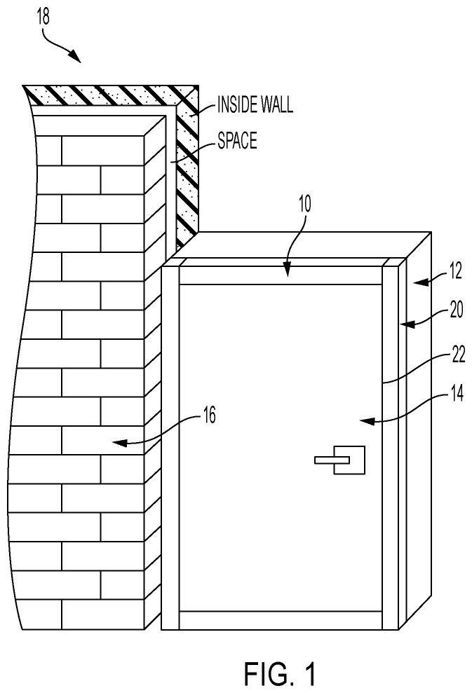

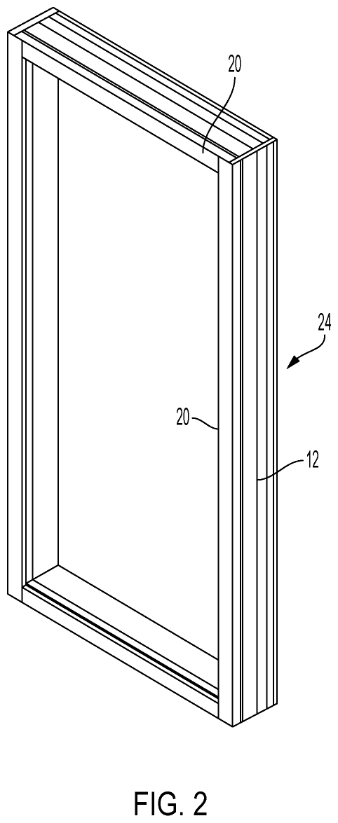

Referring now to FIGS. 1, 2, and 3, there is illustrated generally at 10 an apparatus that renders a door frame 12 and a door slab 14 co-planar (flush) with an exterior wall 16 of a building 18. In essence, the apparatus 10 is a combination of a one-piece clip member 20 and a door frame piece 24.

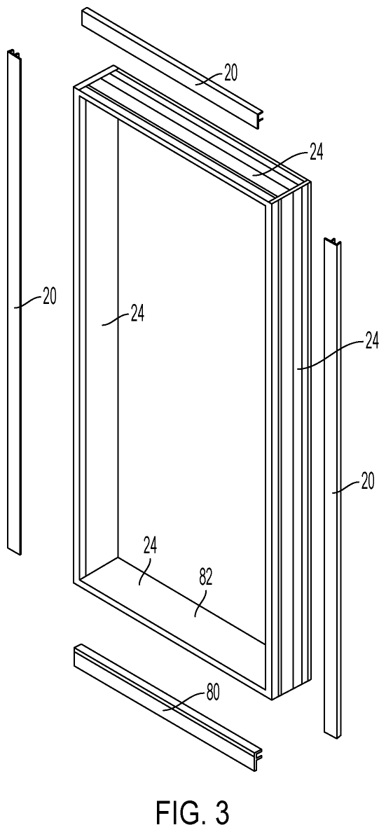

As best shown in FIG. 3, the door frame 12 typically includes four door frame pieces 24 that connect to form a generally rectangular frame. The four-sided rectangular frame is located snug into a doorway opening and sealed in place using caulk, foam insulation and other means known to those skilled in the art. As noted above, the one-piece clip member 20 when in place allows the door frame 12 and the door slab 14 to be located co-planar (flush) with the exterior wall 16 of the building 18. This improves the aesthetic appearance of the doorway so as to give the impression of a smooth building exterior. This has a number of advantages, not least of which is to prevent snow and ice accumulation in the doorway recess in environments that have regular cold and snowy winters. When located, the clip member 20 covers a perimeter area 22 of the door slab 14 and the door frame 12 so that an observer looking from the front will see only a smooth continuous area.

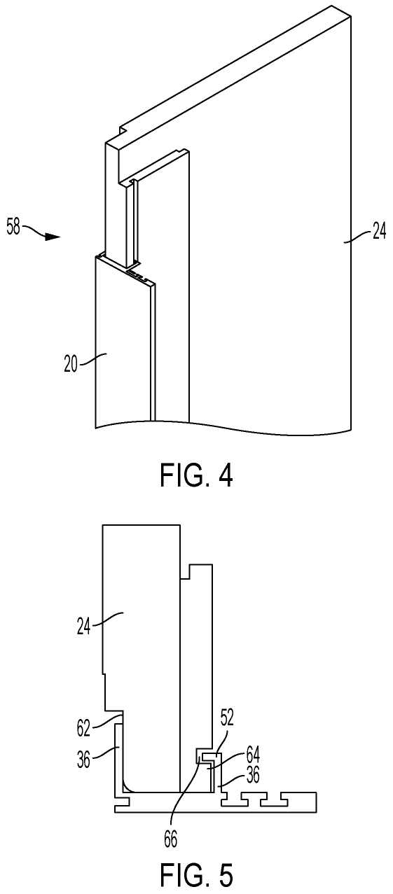

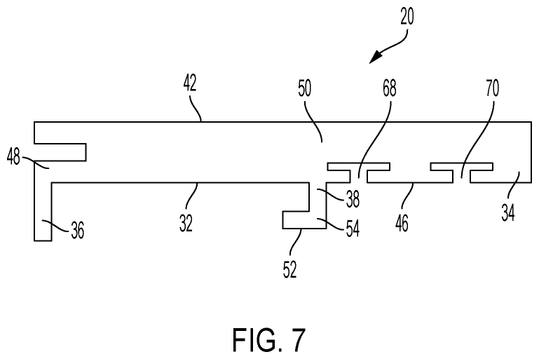

As best seen in FIGS. 4, 5 and 6, the clip member 20 is a relatively thin sheet of material that is machined to taken on the appearance as illustrated in FIG. 7. The clip member 20 has a front strip 30 which includes a door frame shielding portion 32 and a door slab perimeter shielding portion 34 which extends in a linear fashion from the door frame shielding portion 32, and are thus connected together. The clip member 20 has a first connector sidewall 36 and a second connector sidewall 38 extending from the door frame shielding portion 32 towards a building interior 40.

Combined, the door slab perimeter shielding portion 34 and the door frame shielding portion 32 have a front facing surface 42, which is disposed away from the door frame 12 and the door slab 14, and a rear facing surface 46 which is disposed inwardly towards the building interior 40.

The first connector sidewall 36 is connected to a first end portion 48 of the door frame shielding portion 32 and extends inwardly therefrom towards the building interior 40. The first connector sidewall 36 is disposed orthogonal (at 90 degrees), to the door frame shielding portion 32. The second connector sidewall 38 is connected to a second end portion 50 of the door frame shielding portion 32 and extends inwardly therefrom towards the building interior 40 and lies substantially parallel and spaced apart from the first connector sidewall 36. As with the first connector sidewall 36, the second connector sidewall 38 is disposed orthogonal relative to the door frame shielding portion 32. The second connector sidewall 38 includes an anchor portion 52 connected to an end portion 54 of the second connector sidewall 38. The anchor portion 52 is disposed orthogonally from the second connector sidewall 38 and thus into the door frame 12. When fully assembled, (see below), the anchor portion 52 is orientated towards a building wall portion 56.

Referring now to FIGS. 4 and 5, the door frame 12 includes a front face 58 that includes a clip member receiving portion 60. The clip member receiving portion 60 is shaped to be complementary to the clip member 20 to permit sealing engagement therewith for a secure assembly.

The door frame face 58 is disposed away from the building interior 40 and includes a first recess 62 to sealingly receive and engage the first connecting sidewall 36 of the clip member 20. The door frame face 58 also includes a second recess 64 to sealingly receive and engage therein the second connecting sidewall 38. Finally, the door frame face 58 includes a third recess 66 to sealingly receive and engage therein the anchor portion 52.

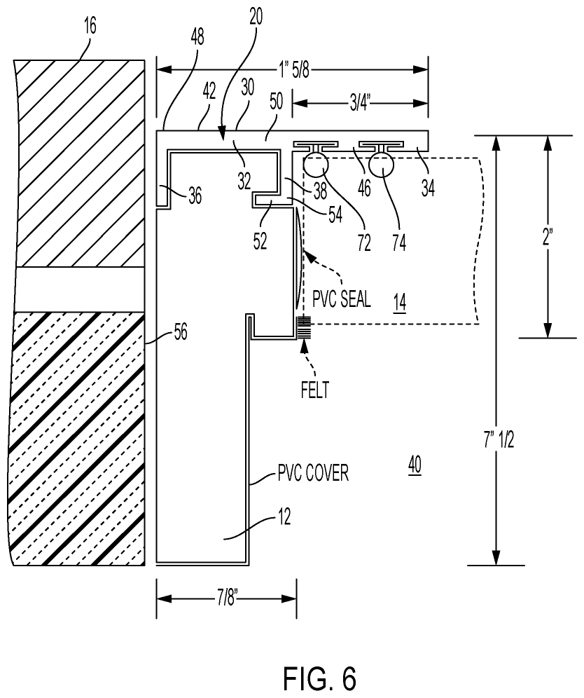

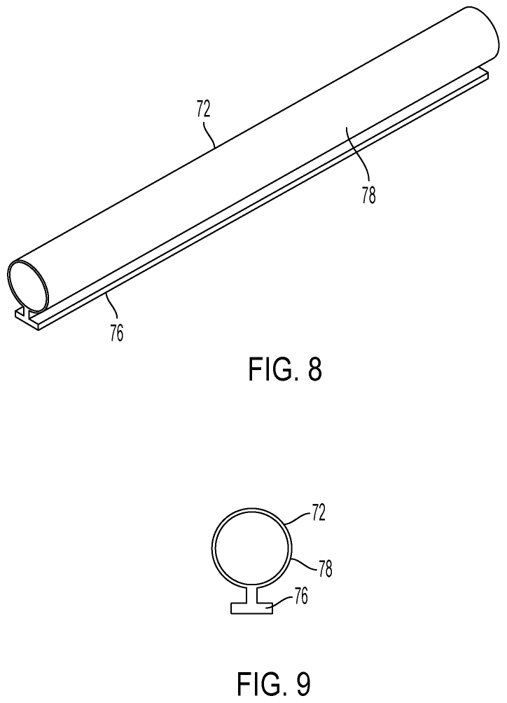

As best seen in FIGS. 6, 7, 8 and 9, the door slab shielding portion includes a first seal recess 68 and a second spaced seal recesses 70 spaced apart from the first seal recess 68 to receive therein first and second seals 72, 74. The seals 72, 74 are rubber gaskets and include a gasket anchor 76 and a gasket conduit 78, which is resilient and collapses once installed to provide a seal between the door frame 14 and the clip member 20.

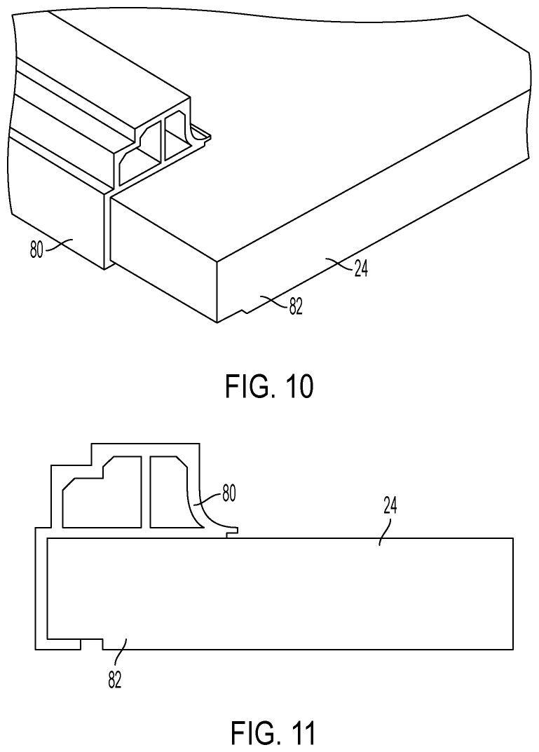

Referring to FIGS. 10 and 11, for the sake of brevity, only one door frame piece and a clip member are described herein. However, for a typical door frame and door slab assembly, there are four door frame pieces. In another example, the door frame includes four frame pieces. A door sill clip 80 is located at a base portion 82 of the door frame 12.

### Assembly

When fully assembled, the door frame shielding portion and the door slab shielding portion are connected together. In one example, they are connected together using glue or some other means of adhesive. A person of ordinary skill in the art will readily understand that many modes of connection are available which would achieve the same desired effects.

After the frame and the clip members, including the door sill clip member are combined, the door frame is assembled. The rest of the insulation strips will be added as on standard present door frames. Only this type of the frame will have one additional weather strip

The door frame 12 is made from kiln dried wood. The wood frame size width is standard 7½ inches. The wood thickness is ⅞ of an inch. The wood frame is slightly recessed from inside, shaved to accommodate easy hinges opening. The aluminum clips are glued from outside of the frame. The clip members 20 can be painted any colour as desired and for weather protection. Advantageously, the clip member 20 functions both as a door stopper and as a weather sealer. The clip member 20 thickness is about approximately 4 mm. The clip members 20 are made from aluminum or any other suitable material known to those skilled in the art. Before assembly, the door frame 12 and the clip members 20 are measured and cut to form the door frame 12, and then glued and clipped together.

The frame is then assembled along with the wood is cut in for hinges. Next, all the weather strips and gaskets are installed and the door slab is hung. The wood frame from the inside is covered with PVC panels. The frame is installed in rough opening, levelled and screwed to building structure. Foam is sprayed between the structure and door frame. The area between the wall and the door frame is finished with caulking. All installation assembly is the same as conventional entrance door frames except the door slab is flush with front of the frame for an aesthetically pleasing, modern look.

Standard weather strip on the bottom of the door slab is used in this door frame.

Once assembly in the door way, the door slab is flush with exterior frame. Looking from inside the building, the door slab is pushed to the front and the wood frame is recessed and covered with PVC cover. This alters the appearance of the whole doors from outside. Once assembled, the observer sees a unique flush door entrance. In essence, this appearance is the reverse look of conventional entrance doors. New exterior door frame for use mostly in all residential home or commercial buildings if permitted.

### Other Embodiments

From the foregoing description, it will be apparent to one of ordinary skill in the art that variations and modifications may be made to the embodiments described herein to adapt it to various usages and conditions.

What is claimed is:

1. An apparatus for covering a door frame and a door slab perimeter, the apparatus comprising:
a clip member having a door frame shielding portion and a door slab perimeter shielding portion extending therefrom, the clip member having first and second connector sidewalls extending from the door frame shielding portion towards a building interior; and
a clip member receiving portion located at one face of the door frame, the clip member receiving portion being shaped to be complementary to the clip member to permit sealing engagement therewith.

2. The apparatus, according to claim 1, in which the door frame shielding portion and the door slab perimeter shielding portion are connected together.

3. The apparatus, according to claim 1, in which the door slab perimeter shielding portion and the door frame shielding portion have a front facing surface which is disposed away from the door frame and the door slab; and a rear facing surface which is disposed inwardly towards the building interior.

4. The apparatus, according to claim 1, in which:
the first connector sidewall is connected to a first end portion of the door frame shielding portion and extending inwardly therefrom towards the building interior, the first connector sidewall being disposed orthogonal to the door frame shielding portion; and
the second connector sidewall is connected to a second end portion of the door frame shielding portion and extending inwardly therefrom towards the building interior, the second connector sidewall is disposed orthogonal to the door frame shielding portion.

5. The apparatus, according to claim 4, in which the second connector sidewall includes an anchor portion connected to an end portion of the second connector sidewall, the anchor portion being orthogonally disposed into the door frame and is orientated towards a building wall portion.

6. The apparatus, according to claim 4, in which the door frame includes:
a door frame face disposed away from the building interior and includes:
i) a first recess to sealingly receive therein the first connecting sidewall;
ii) a second recess to sealingly receive therein the second connecting sidewall; and
iii) a third recess to sealingly receive therein the anchor portion.

7. The apparatus, according to claim 1, in which the door slab shielding portion includes first and second spaced apart recesses to receive therein first and second seals.

8. The apparatus, according to claim 7, in which the first and second seals are rubber gaskets.

9. The apparatus, according to claim 1, in which the clip member is one-piece.

10. The apparatus, according to claim 1, which the door frame includes four frame pieces.

11. The apparatus, according to claim 10, in which a door sill clip is located at a base portion of the door frame.

12. An apparatus for covering a door frame and a perimeter of a door slab, the apparatus comprising:
a clip member having a door frame shielding portion and a door slab perimeter shielding portion extending therefrom, the clip member having first and second connector sidewalls extending from the door frame shielding sidewall, the door slab perimeter shielding portion and the door frame shielding portion have a front facing surface which is disposed away from the door frame and the door slab; and a rear facing surface disposed inwardly towards a building interior;
the first connector sidewall is connected to a first end portion of the door frame shielding portion and extending inwardly therefrom towards the building interior, the first connector sidewall being disposed orthogonal to the door frame shielding portion;
the second connector sidewall is connected to a second end portion of the door frame shielding portion and extending inwardly therefrom towards the building interior, the second connector sidewall is disposed orthogonal to the door frame shielding portion;
the second connector sidewall includes an anchor portion connected to an end portion of the second connector sidewall, the anchor portion is orthogonally disposed into the door frame and is orientated towards a building wall portion.

13. The apparatus, according to claim 12, in which the door slab perimeter shielding portion includes first and second spaced apart recesses to receive therein first and second seals.

14. The apparatus, according to claim 13, in which the first and second seals are rubber gaskets.

15. The apparatus, according to claim 12 in which the clip member is one-piece.

16. A door frame for a door, the door frame comprising:
first, second and third frame pieces, each frame piece having a contoured outer surface that are shaped to receive in a connecting manner, first, second and third clip members;
each frame piece having a clip member receiving portion located at a door frame face, the clip member receiving portion being shaped to be complimentary to the clip member to permit sealing engagement therewith;
the door frame face includes:
i) a first recess to snuggly receive therein the first connecting sidewall in a sealing engagement;
ii) a second recess to snuggly receive therein the second connecting sidewall in a sealing engagement; and
iii) a third recess to snuggly receive therein the anchor portion.

17. The door frame, according to claim 16, further includes a door sill located at a base portion of the door frame and having a contoured outer surface that is shaped to receive in a door sill clip member.

18. A clip for use with a door frame and a perimeter of a door slab to cover same, the clip comprising
a door frame shielding portion and a door slab perimeter shielding portion extending therefrom;
first and second connector sidewalls extending from the door frame shielding sidewall, the door slab perimeter shielding portion and the door frame shielding portion have a front facing surface which is disposed away from the door frame and the door slab; and
a rear facing surface disposed inwardly towards a building interior;
the first connector sidewall is connected to a first end portion of the door frame shielding portion and extending inwardly therefrom towards the building interior, the first connector sidewall being disposed orthogonal to the door frame shielding portion;
the second connector sidewall is connected to a second end portion of the door frame shielding portion and extending inwardly therefrom towards the building interior, the second connector sidewall is disposed orthogonal to the door frame shielding portion;
the second connector sidewall includes an anchor portion connected to an end portion of the second connector sidewall, the anchor portion is orthogonally disposed into the door frame and is orientated towards a building wall portion.

19. The clip, according to claim 18, in which the door slab perimeter shielding portion includes first and second spaced apart recesses to receive therein first and second seals.

20. The clip, according to claim 19, in which the first and second seals are rubber gaskets.

21. The clip, according to claim 18, is one-piece.
